(19) United States
(12) Patent Application Publication
(10) Pub. No.: US 2023/0052598 A1
(43) Pub. Date: Feb. 16, 2023

(54) VENETIAN BLIND ADJUSTMENT DEVICE

(71) Applicant: Leafy Windoware Co., Ltd., Dongguan City (CN)

(72) Inventors: Zhenbang LEI, Dongguan City (CN); Xingbang LEI, Dongguan City (CN)

(21) Appl. No.: 17/464,693

(22) Filed: Sep. 2, 2021

(30) Foreign Application Priority Data
Aug. 11, 2021 (CN) 202121882031.6

(51) Int. Cl. E06B 9/322; F16H 1/16

(52) U.S. Cl. CPC E06B 9/322; F16H 1/16

(57) ABSTRACT

A venetian blind adjustment device includes a hollow bottom shell, a worm and worm wheel mechanism arranged in the bottom shell, an operation member, and a cover. The bottom shell includes two opposite sidewalls, and defines an opening in a top and between tops of the sidewalls. The worm and worm wheel mechanism includes a worm and a worm wheel. An end of the operation member extends into the bottom shell and is connected to the worm. The cover is mounted to the bottom shell to close the opening. Two ends of the worm wheel are rotatably mounted to the sidewalls of the bottom shell, and two limit hooks extend down toward the bottom shell from opposite sides of the cover, to abut against outer surfaces of the sidewalls, respectively.

### FIELD OF THE PRESENT INVENTION

The present invention relates to window shade accessories technical field and, more particularly to a venetian blind adjustment device.

### BACKGROUND OF THE PRESENT INVENTION

A venetian blind body is composed of a plurality of slats connected in series with several cords. In order to facilitate the control of the light transmission of the blind, an angle adjustment device is often added to the blind. A common angle adjustment device usually includes a worm wheel, a worm that is meshed and connected with the worm wheel, and two side shells that are arranged at opposite sides to house the worm wheel and the worm therein. In use, power is applied on the worm to cause the worm to rotate, and then the worm drives the worm wheel meshed with the worm to rotate. A center of the worm wheel defines a non-circular shaft hole in an axial direction to output power to realize the retracting or unwinding of a pull cord, thereby adjusting the angle of the slats to change the light transmission of the blind.

However, during the angle adjustment operation, the external force drives the worm to rotate, and a spiral structure on the worm generates an axial component force on the worm wheel during the meshing transmission process. The worm wheel is forced to produce axial displacement and squeeze the two side shells. The side shells are easy to split and the structure is unstable.

### SUMMARY OF THE INVENTION

Therefore, the technical problem to be solved by the embodiments of the present invention is to provide a venetian blind adjustment device with stable structure.

To solve the above-mentioned technical problems, an embodiment of the present invention provides a venetian blind adjustment device. The venetian blind adjustment device includes a hollow bottom shell, a worm and worm wheel mechanism, an operation member, and a cover. The bottom shell includes two opposite sidewalls, and defines an opening in a top and between tops of the sidewalls. The worm and worm wheel mechanism is arranged in the bottom shell, and includes a worm and a worm wheel. An end of the operation member extends into the bottom shell and is connected to the worm. The cover is mounted to the bottom shell to close the opening. Two ends of the worm wheel are rotatably mounted to the sidewalls of the bottom shell. Two limit hooks extend down toward the bottom shell from opposite sides of the cover, to abut against outer surfaces of the sidewalls, respectively.

Furthermore, the limit hooks are bent from middles of the corresponding sides of the cover.

Furthermore, a first guiding inclined surface is formed at a junction of a distal end surface and an inner surface of each limit hook.

Furthermore, two coaxial pivot shafts extend from corresponding ends of the sides of the cover, respectively, an end of the bottom shell correspondingly defines two pivot holes, and the cover is rotatably mounted to the bottom shell through the pivot shafts rotatably engaged in the corresponding pivot holes.

Furthermore, two pivot tabs extend up from corresponding ends of the sidewalls of the bottom shell, the pivot holes are defined in the pivot tabs, respectively.

Furthermore, the pivot holes are open slots defined in outer sides of the pivot tabs and extending toward inner sides of the pivot tabs; the pivot shafts enter the slots through openings of the slots, and abut against portions of sidewalls bounding the slots opposite to the openings of the slots.

Furthermore, inner sides of portions of the sidewalls bounding the slots at the openings form stop steps, to prevent the pivot shafts from slipping off the slots.

Furthermore, two coaxial clamping shafts extend from corresponding ends of the sides of the cover away from the pivot shafts, the bottom shell defines two clamping holes, and the clamping shafts are engaged in the corresponding clamping holes.

Furthermore, two clamping tabs extend up from the corresponding ends of the cover, the clamping holes are defined in the clamping tabs, respectively, an inner surface of each clamping tab forms a second guiding inclined surface extending from a top of the clamping tab toward a corresponding clamping hole, and an end surface of each clamping shaft forms a third guiding inclined surface, corresponding to the second guiding inclined surface.

Furthermore, the pivot shafts and the clamping shafts have the same shape and are arranged symmetrically with each other.

By adopting the above technical solution, embodiments of the present application have at least the following beneficial effects. In the embodiments of the present application, the cover is mounted to the bottom shell to close the opening of the bottom shell, and the two limit hooks extend down toward the bottom shell from the opposite sidewalls of the bottom shell rotatably mounted with the worm wheel, to abut against the outer surfaces of the sidewalls. Therefore, in actual use, when the worm wheel is subjected to the force of the worm to push the corresponding sidewalls of the bottom shell outward, the limit hooks can limit the sidewalls from the outer surfaces of the two opposite sidewalls of the bottom shell. The thrust force of the worm wheel on the sidewalls can be effectively overcome, and serious deformation of the sidewalls can be avoided, the structural stability of the opposite two sidewalls rotatably mounted with the worm wheel can be ensured, and the normal operation of the device can be ensured.

### DESCRIPTION OF THE DRAWINGS

FIG. 1 is an exploded, isometric view of an embodiment of a venetian blind adjustment device, wherein the adjustment device includes a bottom shell, a worm wheel, a worm, and a cover.

FIG. 2 is an assembled, isometric view of FIG. 1.

FIG. 3 is a cross-sectional view of FIG. 2, taken along a central axis of the worm wheel perpendicular to the cover.

FIG. 4 is another cross-sectional view of FIG. 2, taken along a center surface in the thickness direction of one sidewall of the bottom shell.

FIG. 5 is another cross-sectional view of FIG. 2, taken along a central axis surface of the worm which is perpendicular to the central axis of the worm wheel.

### DETAILED DESCRIPTION OF THE PRESENT INVENTION

The present application will be further described in detail below with reference to the accompanying drawings and specific embodiments. It should be understood that the following illustrative embodiments and illustrations are only used to explain the present invention and are not intended to limit the present invention, and that the embodiments of the present invention and the features of the embodiments can be combined with each other without conflict.

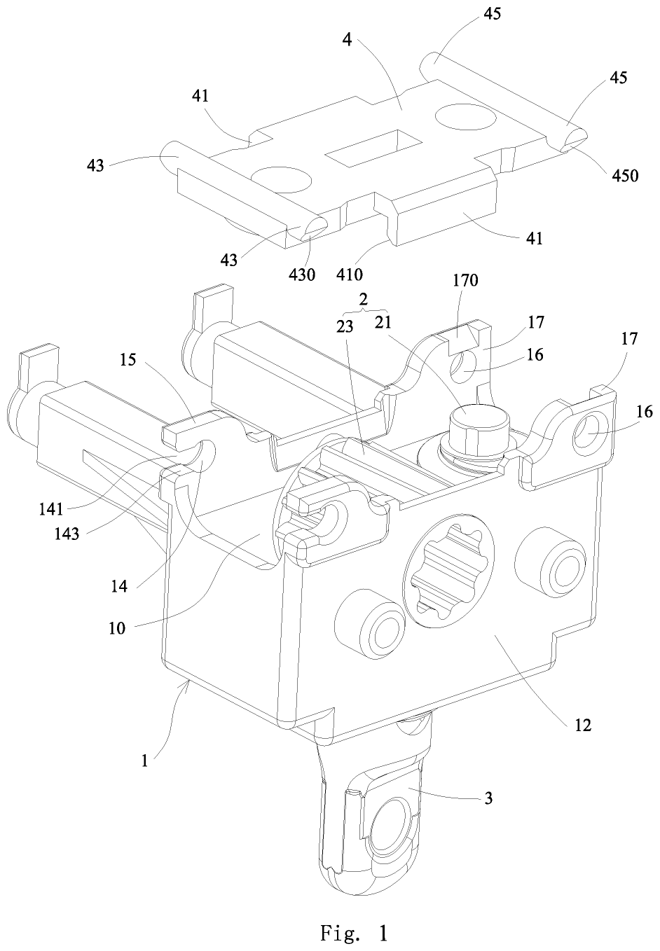

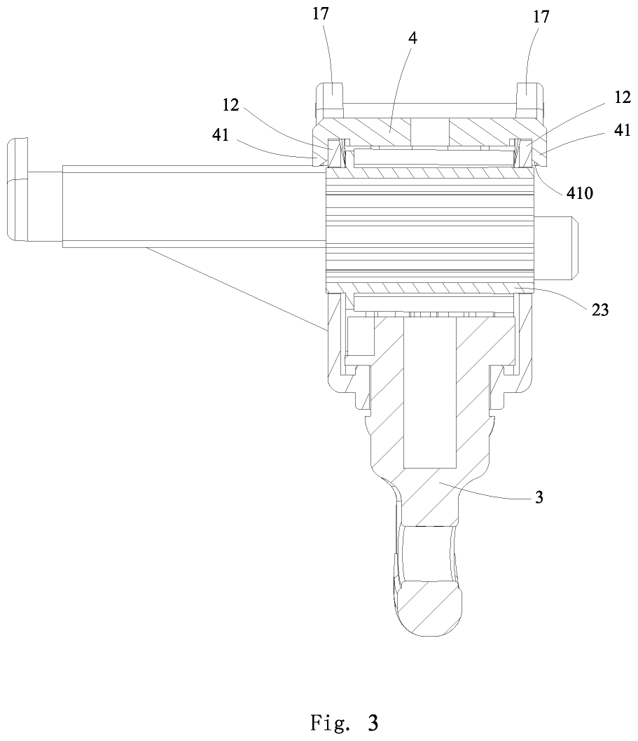

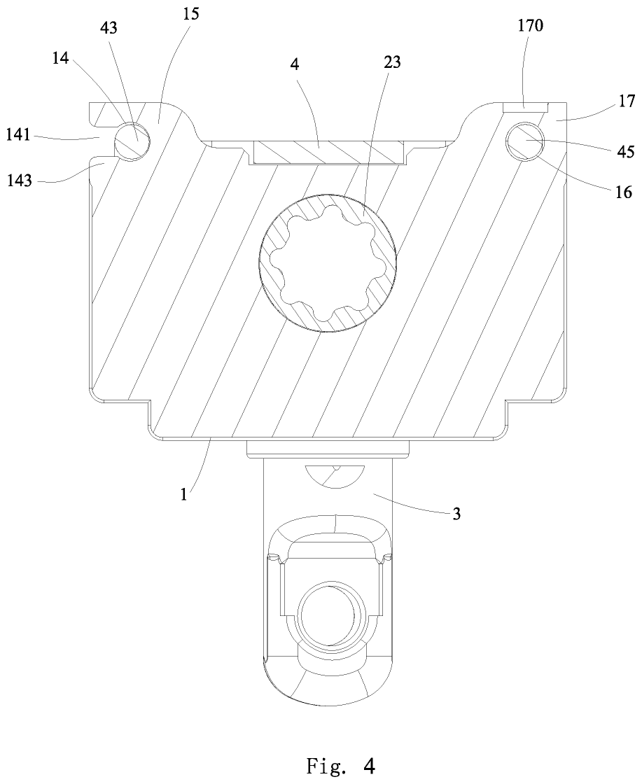

Referring to FIGS. 1 through 5, an embodiment of the present disclosure provides a venetian blind adjustment device. The adjustment device includes a hollow bottom shell 1 defining an opening 10 in a top, a worm and worm wheel mechanism 2 arranged in the bottom shell 1, an operation member 3 with an end extending into the bottom shell 1 and connected to a worm 21 of the worm and worm wheel mechanism 2 in a transmission mode, and a cover 4 mounted to the bottom shell 1 to close the opening 10 of the bottom shell 1. Opposite ends of a worm 23 of the worm and worm wheel mechanism 2 are rotatably mounted to two opposite sidewalls 12 of the bottom shell 1. Two limit hooks 41 extend from opposite sides of the cover 4 toward the bottom shell 1, corresponding to the sidewalls of the bottom shell 1. The limit hooks 41 abut against outer surfaces of the sidewalls 12 rotatably mounted with the worm wheel 23, respectively.

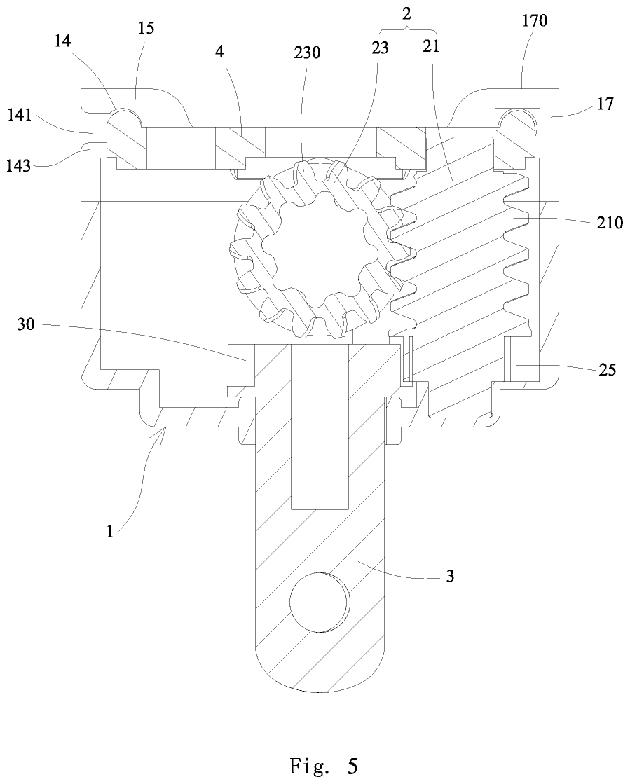

In the embodiment of the present application, the cover 4 is arranged at the opening 10 of the bottom shell 1 to close the opening 10, the limit hooks 41 extend toward the bottom shell 1 from the sides of the cover 4 corresponding to the sidewalls 12 rotatably mounted with the worm wheel 23, and the limit hooks 41 are abutted against the outer surfaces of the sidewalls 12, respectively. In use, power is input through the operation member 3, and the operation member 3 drives the worm 21 to rotate. The worm 21 utilizes its spiral structure 210 to mesh with teeth 230 of the worm wheel 23 to drive the worm wheel 23 to rotate. A component force of the force of the worm 21 on the worm wheel 23 in the axial direction of the worm wheel 23 causes the worm wheel 23 to exert a thrust on the sidewalls 12 of the bottom shell 1 toward the outside of the bottom shell 1, while the limit hooks 41 can perform abutment against the sidewalls 12 from the outer surfaces of the two opposite sidewalls 12 of the bottom shell 1 to limit the sidewalls 12, which can effectively overcome the thrust of the worm wheel 23 on the sidewalls 12, and avoid the serious deformation of the sidewalls 12. It can ensure the structural stability of the two opposite sidewalls 12 of the bottom shell 1 rotatably mounted with the worm wheel 23, and ensure the normal operation of the device. The operation member 3 and the worm 2 can be connected by meshing gears 30 and 25 (as shown in FIG. 5) on proximal ends of the operation member 3 and the worm 2, or it is also possible to adopt a common transmission structure such as the cooperation of a pulley and a belt (not shown in the figures) or a cooperation of a sprocket and a chain (not shown in the figures) to realize the transmission of power.

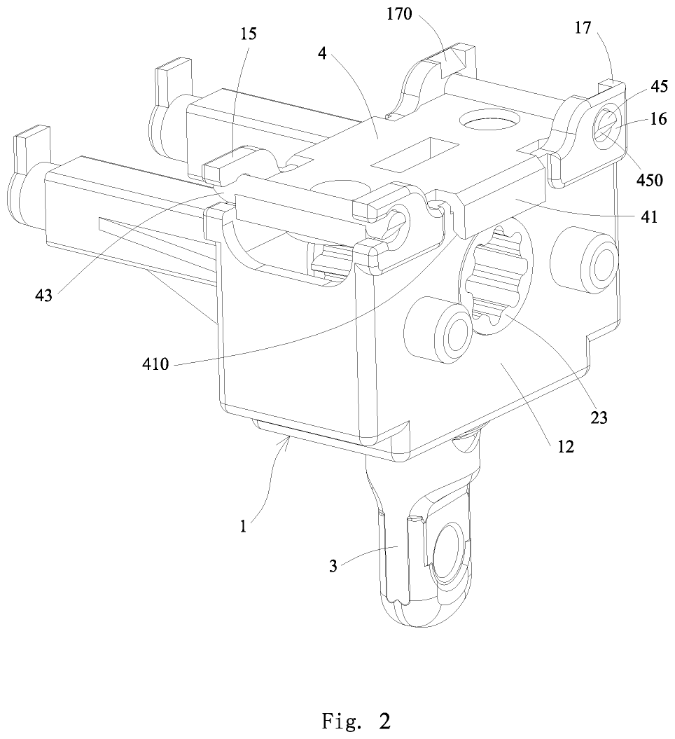

In an embodiment of the present application, referring to FIG. 1 and FIG. 2, the limit hooks 41 are bent and extended from middles of the corresponding sides of the cover 4. Since the two ends of the worm wheel 23 are assembled in middles of the corresponding sidewalls 12 of the bottom shell 1, the middles of the sidewalls 12 are most likely to be deformed under force. In the embodiment, the limit hooks 41 are bent and extended from the middles of the corresponding sides of the cover 4, so that it is possible to more effectively implement abutment and limit on the middles of the corresponding sidewalls 12 of the bottom shell 1 that may be deformed.

In an embodiment of the present application, referring to FIGS. 1-3, a first guiding inclined surface 410 is formed at the junction of a distal end surface and an inner side surface of each limit hook 41. In the embodiment, the first guiding inclined surface 410 is provided at the junction between the distal end surface and the inner side surface of the limit hook 41. During the covering process of the cover 4, the first guiding inclined surfaces 410 of the limit hooks 41 and tops of the corresponding sidewalls 12 of the bottom shell 1 cooperate with each other to guide the limit hooks 41 to be smoothly clamped to the outer surfaces of the corresponding sidewalls 12, and the assembly is convenient and labor-saving.

In an embodiment of the present application, referring to FIG. 1 and FIG. 2, two coaxial pivot shafts 43 extend from corresponding ends of the sides of the cover 4 forming the limit hooks 41, and two pivot holes 14 are defined in the corresponding sidewalls 12 of the bottom shell 1 at an end of the bottom shell 1. The cover 4 is rotatably mounted to the bottom shell 1 through the pivot shafts 43 rotatably engaged in the corresponding pivot holes 14. In the embodiment, the pivot shafts 43 are coaxially provided from the ends of the sides at an end of the cover 4, the pivot holes 14 are provided in the corresponding end of the bottom shell 1, and the cover 4 is rotatably mounted to the bottom shell 1 through the pivot shafts 43 rotatably engaged in the corresponding pivot holes 14, respectively, so as to realize the connection between the cover 4 and the bottom shell 1 and to locate the buckling position of the cover 4 at the same time.

In an embodiment of the present application, referring to FIGS. 1, 2, and 4, two pivot tabs 15 extend up from the ends of the sidewalls 12 at the end of the bottom shell 1, and the pivot tabs 15 extend out of the sidewalls 12. The pivot holes 14 are defined in the pivot tabs 15. In the embodiment, the pivot tabs 15 extend up from the ends of the sidewalls 12 at the end of the bottom shell 1 and extend out of the sidewalls 12, the pivot holes 14 are defined in the pivot tabs 15, and the pivot tabs 15 are protruded relative to the bottom shell 1, to facilitate the pivot shafts 43 on the cover 4 to be inserted into the pivot holes 14.

In an embodiment of the present application, referring to FIGS. 1, 2, and 4, the pivot holes 14 are open slots 14 defined in outer sides of the pivot tabs 15 and extending toward inner sides of the pivot tabs 15. The pivot shafts 43 enter the slots 14 through openings 141 of the slots 14, and abut against portions of sidewalls bounding the slots 14 opposite to the openings 141. In the embodiment, the pivot holes 14 are defined with the openings 141, and the pivot shafts 43 enter the slots 14 through the openings 141 to rotatably connect the cover 4 to the bottom shell 1, which is easy to install, and improves assembly efficiency.

In an embodiment of the present application, referring to FIGS. 1, 2, and 4, inner sides of portions of the sidewalls bounding the slots 14 at the openings 141 form stop steps 143. In the embodiment, the inner sides of the portions of the sidewalls bounding the slots 14 at the openings 141 form the stop steps 143, and thus when assembling, a little force can make the pivot shafts 43 pass the stop steps 143 and enter the inside of the slots 14. At this time, the stop steps 143 can effectively prevent the pivot shafts 43 from slipping off the slots 141, and enhance the stability of the connection between the pivot shafts 43 and the slots 14

In an embodiment of the present application, referring to FIGS. 1, 2, and 5, corresponding ends of the sides of the cover 4 forming the limit hooks 41 coaxially form two clamping shafts 45, at an end of the cover 4 opposite to the pivot shafts 43. Two clamping holes 16 are defined in the bottom shell 1, corresponding to the clamping shafts 45, and the clamping shafts 45 are engaged in the clamping holes 16. In the embodiment, the end of the cover 14 opposite to the pivot shafts 43 coaxially form the clamping shafts 45, and the bottom shell 1 correspondingly forms the clamping holes 16 engaging with the clamping shafts 45. The cover 4 is fixedly connected to the bottom shell 1 through the clamping shafts 45 engaged in the clamping holes 16. The pivot shafts 43 and the clamping shafts 45 are respectively connected to the bottom shell 1 from the opposite ends of the cover 4, and the height position of the cover 4 relative to the bottom shell 1 is fixed to ensure the limiting effect of the limit hooks 41 on the corresponding sidewalls 12.

In an embodiment of the present application, referring to FIGS. 1, 2, and 5, two clamping tabs 17 extend up from the ends of the sidewalls 12 rotatably mounting the worm wheel 23, and the clamping tabs 17 extend out of the sidewalls 12 of the bottom shell 1. The clamping holes 16 are defined in the clamping tabs 17. An inner surface of each clamping tab 17 forms a second guiding inclined surface 170 extending from a top of the clamping tab 17 away from the bottom shell 1 toward the clamping hole 16. An end surface of each clamping shaft 45 forms a third guiding inclined surface 450, corresponding to the second guiding inclined surface 170. In the embodiment, the clamping tabs 17 are extended up from the ends of the bottom shell 1 at the opening 10, and the clamping holes 16 are defined in the clamping tabs 17. The clamping tabs 17 are extended out of the sidewalls 12, and thus during the clamping process, the clamping tabs 17 can be relatively easily and elastically opened to facilitate the clamping shafts 45 to be clamped into the clamping holes 16. At the same time, the second guiding inclined surfaces 170 provided on the inner surfaces of the clamping tabs 17 and the third guiding inclined surfaces 450 provided on the end surfaces of the clamping shafts 45 can cooperate with each other, so that the clamping shafts 45 are abutted against the clamping tabs 17 more smoothly, and the two clamping tabs 17 are correspondingly opened to facilitate the clamping shafts 45 to be clamped into the clamping holes 16, which makes the installation more labor-saving.

In an embodiment of the present disclosure, referring to FIGS. 1 and 2, the pivot shafts 43 and the clamping shafts 45 have the same shape and are arranged symmetrically with each other about the positions on the cover 4. In the embodiment, by setting the pivot shafts 43 and the clamping shafts 45 to have the same shape and to be symmetrically arranged on the cover plate 4, the pivot shafts 43 and the clamping shafts 45 can replace each other in function. Therefore, during actual assembly, it is not necessary to strictly distinguish between the pivot shafts 43 and the clamping shafts 45, and the convenience of assembling the cover 4 can be effectively improved.

The embodiments of the present application have been described above with reference to the accompanying drawings, but the present application is not limited to the specific implementations described above, and the specific implementations described above are only schematic and not limiting. Under the enlightenment of this application, many forms can be made without departing from the scope of this application and the scope of protection of the claims, and these are all included in the scope of protection of this application.

What is claimed is:

1. A venetian blind adjustment device, comprising:
a hollow bottom shell comprising two opposite sidewalls, and defining an opening in a top and between tops of the sidewalls;
a worm and worm wheel mechanism arranged in the bottom shell, and comprising a worm and a worm wheel;
an operation member with an end extending into the bottom shell and connected to the worm; and
a cover mounted to the bottom shell to close the opening;
wherein two ends of the worm wheel are rotatably mounted to the sidewalls of the bottom shell, two limit hooks extend down toward the bottom shell from opposite sides of the cover, to abut against outer surfaces of the sidewalls, respectively.

2. The venetian blind adjustment device of claim 1, wherein the limit hooks are bent from middles of the corresponding sides of the cover.

3. The venetian blind adjustment device of claim 2, wherein a first guiding inclined surface is formed at a junction of a distal end surface and an inner side surface of each limit hook.

4. The venetian blind adjustment device of claim 1, wherein a first guiding inclined surface is formed at a junction of a distal end surface and an inner side surface of each limit hook.

5. The venetian blind adjustment device of claim 1, wherein two coaxial pivot shafts extend from corresponding ends of the sides of the cover, respectively, an end of the bottom shell correspondingly defines two pivot holes, the cover is rotatably mounted to the bottom shell through the pivot shafts rotatably engaged in the corresponding pivot holes.

6. The venetian blind adjustment device of claim 5, wherein two pivot tabs extend up from corresponding ends of the sidewalls of the bottom shell, the pivot holes are defined in the pivot tabs, respectively.

7. The venetian blind adjustment device of claim 6, wherein the pivot holes are open slots defined in outer sides of the pivot tabs and extending toward inner sides of the pivot tabs; the pivot shafts enter the slots through openings of the slots, and abut against portions of sidewalls bounding the slots opposite to the openings of the slots.

8. The venetian blind adjustment device of claim 7, wherein inner sides of portions of the sidewalls bounding the slots at the openings form stop steps, to prevent the pivot shafts from slipping off the slots.

9. The venetian blind adjustment device of claim 5, wherein two coaxial clamping shafts extend from corresponding ends of the sides of the cover away from the pivot shafts, the bottom shell defines two clamping holes, and the clamping shafts are engaged in the corresponding clamping holes.

10. The venetian blind adjustment device of claim 6, wherein two coaxial clamping shafts extend from corresponding ends of the sides of the cover away from the pivot shafts, the bottom shell defines two clamping holes, and the clamping shafts are engaged in the corresponding clamping holes.

11. The venetian blind adjustment device of claim 10, wherein two clamping tabs extend up from the corresponding ends of the cover, the clamping holes are defined in the clamping tabs, respectively; wherein an inner side surface of each clamping tab forms a second guiding inclined surface extending from a top of the clamping tab toward a corresponding clamping hole, and an end surface of each clamping shaft forms a third guiding inclined surface, corresponding to the second guiding inclined surface.

12. The venetian blind adjustment device of claim 9, wherein two clamping tabs extend up from the corresponding ends of the cover, the clamping holes are defined in the clamping tabs, respectively; wherein an inner surface of each clamping tab forms a second guiding inclined surface extending from a top of the clamping tab toward a corresponding clamping hole, and an end surface of each clamping shaft forms a third guiding inclined surface, corresponding to the second guiding inclined surface.

13. The venetian blind adjustment device of claim 12, wherein the pivot shafts and the clamping shafts have the same shape and are arranged symmetrically with each other.

14. The venetian blind adjustment device of claim 11, wherein the pivot shafts and the clamping shafts have the same shape and are arranged symmetrically with each other.
